(19) United States
(12) Patent Application Publication
(10) Pub. No.: US 2026/0243383 A1
(43) Pub. Date: Aug. 20, 2026

(54) HOSE LOOM ARRANGEMENT AND METHOD OF MANUFACTURE THEREOF

(71) Applicant: MTC CONTRACTORS PTY LTD, Bracalba, Queensland (AU)

(72) Inventor: Robert HUNTER, Gold Coast, Queensland (AU)

(73) Assignee: MTC CONTRACTORS PTY LTD, Bracalba, Queensland (AU)

(21) Appl. No.: 19/099,293

(22) PCT Filed: Jul. 21, 2023
(86) PCT No.: PCT/AU2023/050667

§ 371 Date: Jan. 28, 2025

Related U.S. Application Data
(60) Provisional application No. 63/393,338, filed on Jul. 29, 2022.

(51) Int. Cl. F16L 57/00; B29C 39/10

(52) U.S. Cl. CPC F16L 57/00; B29C 39/10; B29K 2875/00

(57) ABSTRACT

A hose loom comprises a polymer body through which a plurality of hydraulic hoses extend. The polymer body is generally cylindrical. A plurality of annular recesses are spaced axially along the polymer body. At least one bracing member is embedded within the polymer body, ensuring that the hydraulic hoses are spaced from a lower wall of the polymer body.

### FIELD OF THE INVENTION

The present invention relates to a hose loom, that is, a tube surrounding a plurality of hoses.

### BACKGROUND TO THE INVENTION

It is frequently necessary to provide hydraulic fluid under pressure via a hydraulic hose. Such pressurised supply involves several dangers, including the danger of hose blowout and the danger of hose breaching, resulting in a high pressure jet of fluid being released.

In order to alleviate these dangers, it is often prudent to provide a protective covering about a hydraulic hose.

Often, multiple hoses are required to provide hydraulic fluid to a number of independent actuators. Such hoses may extend in parallel along much of their length. In this situation, the hoses may be loosely bound together. It is often preferable, however, to surround at least a portion of the extent of the hoses in a single tube, or loom.

Australian patent number 2011103296 describes the use of a straight loom containing a plurality of hydraulic hoses which are encased in cold castable polyurethane. This loom has proved highly effective in many situations. A number of limitations have been identified, however, in other situations. The loom of Australian patent number 2011103296 is not sufficiently flexible for many applications. It is also considered that the loom may not be sufficiently strong in some instances.

### SUMMARY OF THE INVENTION

According to one aspect of the present invention there is provided a hose loom arrangement comprising:
a plurality of hoses; and
a polymer body extending in a longitudinal direction, the polymer body encasing an axially extending portion of each of the hoses, wherein the polymer body includes a plurality of annular recesses longitudinally spaced along the polymer body.

It is preferred that each annular recess has an internal diameter which is greater than 80% of that of the polymer body.

It is preferred that each annular recess has an internal diameter which is less than 95% of that of the polymer body.

It is preferred that the hose loom arrangement includes at least one bracing member, the bracing member having a curved arm, the curved arm having a convex outer edge and a concave inner edge, the convex outer edge locating internally of an outer surface of the polymer body.

The convex outer edge of the curved arm preferably has a radius of curvature less than that of the polymer body.

The bracing member preferably includes at least two legs, the legs extending between the convex outer edge of the curved arm and the outer surface of the polymer body.

It is preferred that the polymer body is formed from a hot cure urethane.

According to a second aspect of the present invention there is provided a method for forming a hose loom arrangement, the method comprising the steps of:
providing a generally cylindrical mould;
locating a plurality of hoses such that an axially extending portion of each hose is within the generally cylindrical mould;
applying tension to each of the hoses such that the hoses extend through the mould in a generally linear fashion, the hoses being parallel to each other;
introducing a urethane resin into the mould; and
allowing the urethane to cure.

It is preferred that the mould is arranged such that its longitudinal axis is generally horizontal.

The method preferably includes the additional step of locating at least one bracing member between a base of the mould and the hoses before introducing the urethane resin. The bracing member is preferably as described above.

It is preferred that the mould be heated to between 20° and 100° C. The urethane resin introduced is preferably a hot cure urethane.

In a preferred embodiment the mould includes a heating blanket arranged to overlay at least a portion of the mould. The heating blanket may include a continuous copper pipe extending therethrough, the copper pipe being arranged to have heated fluid circulated therethrough in order to heat the blanket and thus the mould.

The mould preferably includes a plurality of rings spaced axially along the mould, each ring having an outer diameter equal to that of the mould and an internal diameter greater than 80% of the outer diameter. It will be understood that the rings act to form annular recesses spaced along a cured body of the house loom arrangement.

Each ring preferably has an internal diameter less than 95% of the outer diameter.

It is preferred that the mould is located within a tensioning unit, the tensioning unit having two complementary outer plates, each of the outer plates being provided with a plurality of apertures, such that each of the plurality of hoses corresponds with an aperture of a first outer plate and a corresponding aperture of the second outer plate, the outer plates being parallel to each other and spaced apart. In a preferred embodiment each of the apertures is associated with an internally threaded member which is arranged to receive a threaded rod. The threaded rod has an outer end which is connected to an outer end of the respective hose. The step of applying tension to the hoses is preferably achieved by rotation of the threaded rods relative to the internally threaded members to effect axial movement of the threaded rod. The internally threaded members may be integral to the apertures, and may indeed be formed by simply threading the apertures. In a preferred embodiment, the internally threaded members are nuts located on an outer face of each outer plate.

The urethane resin is preferably introduced through at least one mould funnel. It is preferred that the mould funnel(s) is located at a top of the mould.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a perspective of a hose loom arrangement in accordance with the present invention;

FIG. 2 is a perspective of a mould used in the making of the hose loom of FIG. 1, shown in a closed position;

FIG. 3 is a perspective of the mould of FIG. 2 in an open position;

FIG. 4 is a see-through perspective of a portion of the mould of FIG. 5;

FIG. 5 is a see-through perspective of a portion of the hose loom arrangement of FIG. 1;

FIG. 6 is a see-through perspective of a portion of the hose loom arrangement of FIG. 1 shown during moulding;

FIG. 7 is a perspective of the mould of FIG. 2 shown during use; and

FIG. 8 is a perspective of alternative embodiments of the hose loom arrangement of FIG. 1.

### DETAILED DESCRIPTION OF PREFERRED EMBODIMENTS

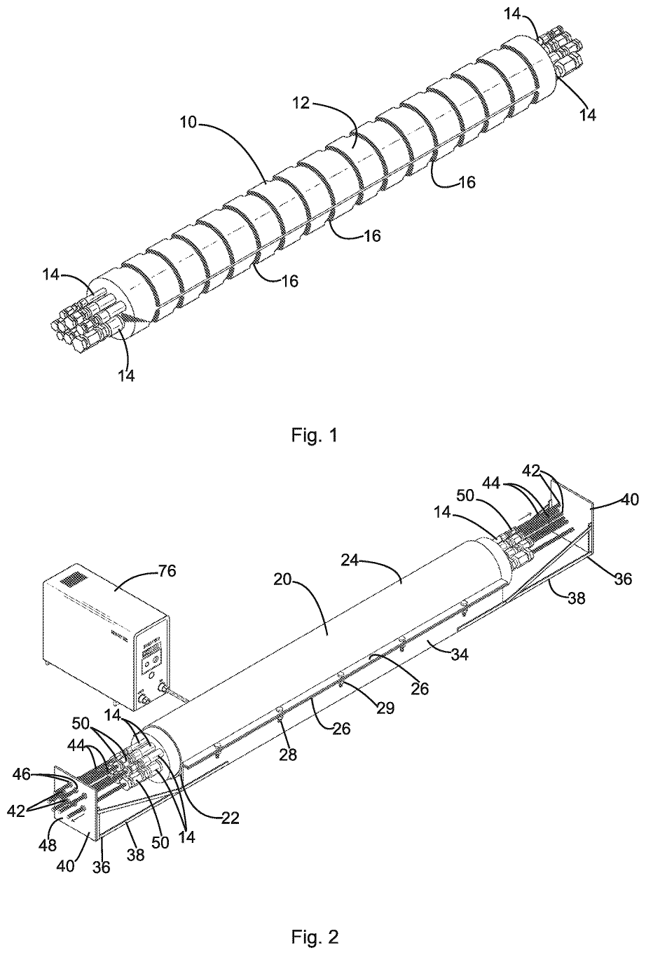

Referring to the Figures, FIG. 1 shows a hose loom arrangement 10. The hose loom comprises a body 12 formed from a hot cure urethane, through which a plurality of hydraulic hoses 14 extend.

The body 12 is generally cylindrical in shape, having a longitudinal axis. The body 12 includes a plurality of annular recesses 16 spaced along its length. Each of the annular recesses 16 extends inwardly of an outer wall of the body 12 by about 10% of the radius of the body 12. It will be appreciated that the combination of a hot cure urethane together with the spaced annular recesses 16 result in a body which is flexible, and able to be readily curved or coiled.

The hydraulic hoses 14 each extend in the axial direction, and are generally parallel to each other. In the embodiment of FIG. 1 there are eight such hydraulic hoses 14. The hydraulic hoses 14 are positioned such that each one is well within the annular recesses 16, with a quantity of urethane between the outermost hydraulic hose 14 and the recessed side wall of the body 12.

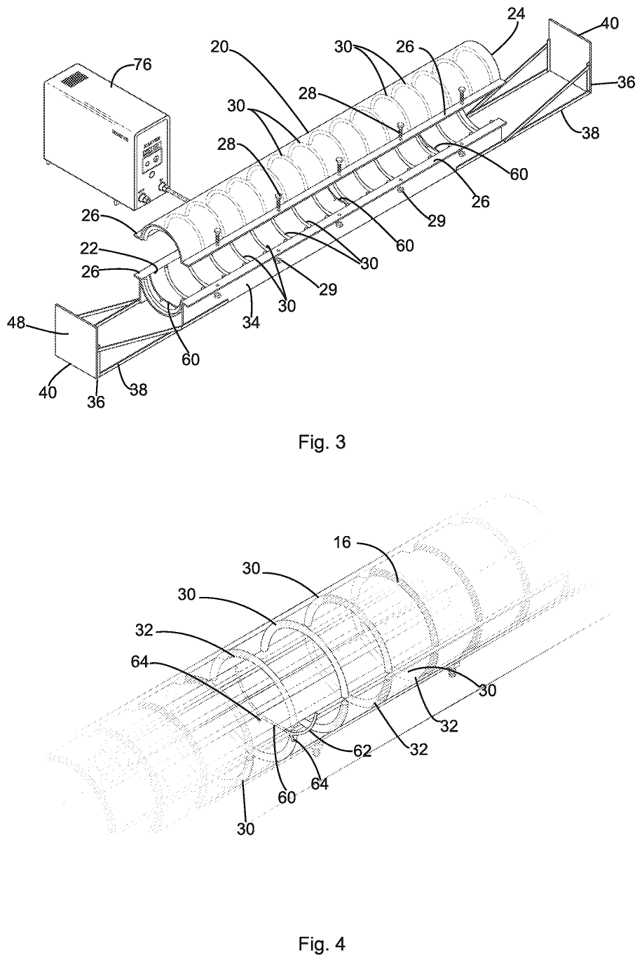

The hose loom arrangement 10 of FIG. 1 is formed using the mould 20 of FIGS. 2 and 3.

The mould 20 comprises two hemicylindrical casings, a lower casing 22 and an upper casing 24. Each of the lower casing 22 and upper casing 24 has an elongate flange 26 extending radially away from either side of the casing 22, 24. The arrangement is such that the elongate flanges 26 of the lower casing 22 can be bolted to the elongate flanges 26 of the upper casing 24 by bolts 28 and associated nuts 29 in order to form an internal cylindrical shape of the mould 20.

A plurality of semi-circular ring portions 30 is located along the internal face of each of the lower casing 22 and the upper casing 24. The ring portions 30 of the lower casing are aligned with the ring portions 30 of the upper casing 24 so as to form nearly complete rings 32 within the mould 20.

The rings 32 have an outer radius equal to the internal radius of the mould 20; that is, they locate against an internal face of the mould 20. The circular rings 32 have an internal radius about 10% smaller than their outer radius; that is, about 90% of the internal radius of the mould 20. It is considered that rings 32 having an internal radius of between about 80% and 95% of the mould 20 internal radius will provide a useful result. It will be appreciated that the rings 32 create the annular recesses 16 of the body 10. This is shown in FIG. 6.

The lower casing 22 of the mould 20 is located in a frame 34. The frame 34 has a hose tensioning assembly 36 affixed to each axial end thereof.

Each hose tensioning assembly 36 includes a horizontal supporting member 38 which is fixed to the frame 34 at one end and extends away from the frame 34 in an axial direction. The hose tensioning assembly 36 includes a vertical outer plate 40 which is perpendicular to the supporting member 38 and locates in a radially aligned plane relative to the mould 20.

The outer plate 40 includes a plurality of apertures 42. Each aperture 42 is arranged to receive a threaded rod 44. Each aperture 42 includes an internally threaded nut 46 which is arranged to bear against an outer face 48 of the outer plate 40, and to engage with the threaded rod 44.

In order to prepare the hose loom arrangement 10 for forming, the hydraulic hoses 14 are introduced into the lower casing 22 of the mould 20. Each hose 14 has a coupling 50 at either end. The arrangement is such that the hose 14 extends beyond the mould 20 a short way at either axial end of the mould 20, with the coupling 50 located beyond the mould 20.

Each coupling 50 is connected to a threaded rod 44. It will be appreciated that the number of apertures 42 in the outer plates 40, and their respective locations, correspond to the number and arrangement of the hydraulic hoses 14. It will further be appreciated that the two outer plates 40 are complementary in shape, with the arrangement of the apertures 42 being a mirror image between the two.

Rotation of the nuts 46 causes axial movement of the threaded rods 44. In this way the combination of the tensioning assemblies 36 acts as a tensioning unit 52, able to apply tension to the hoses 14 to hold them reasonably straight and horizontal.

A plurality of bracing members or saddles 60 are positioned along the lower casing 22. Each saddle 60 has a curved arm 62 and two legs 64.

The curved arm 62 is part-circular, curving through about 150°. It has a radius of curvature about 80% that of the lower casing 22. The two legs 64 are spaced about 60° apart along the curved arm 62, and are sized so as to rest against the internal surface of the lower casing 22 such that the curved arm 62 is positioned with its centre of curvature close to that of the lower casing 22.

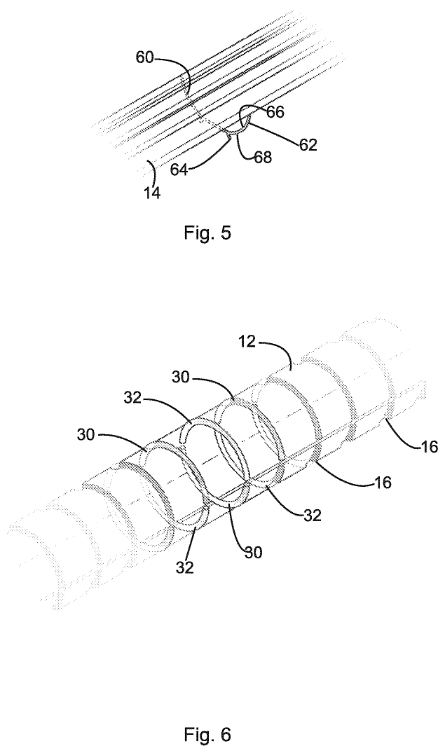

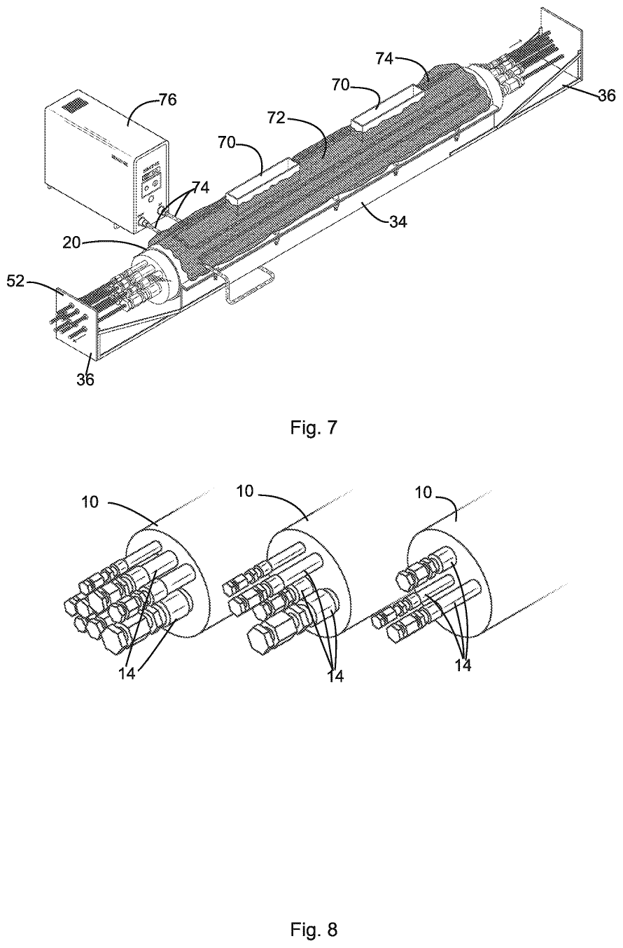

It will be appreciated that the curved arm 62 has a concave inner edge 66 and a convex outer edge 68. The arrangement is such that any sag in the hoses 14 means that a lowermost hose 14 will rest against the curved arm 62, and thus be spaced from the lower casing 22. This is shown schematically in FIG. 5.

Once the hydraulic hoses 14 have been tensioned by the tensioning unit 52, and the saddles 60 positioned appropriately within the lower casing 22, the mould 20 can be completed by the bolting of the upper casing 24 to the lower casing 22.

The upper casing 24 is equipped with two mould funnels 70 located along the top of the upper casing 24.

Before polymer resin is introduced into the mould funnels 70, the mould 20 is prepared for heating by means of a heating blanket 72. The heating blanket 72 is laid over the mould 20, draping down the sides. The heating blanket 72 includes copper tubing 74 winding therethrough, the copper tubing 74 being connected to a heater 76 including a pump. The arrangement is such that the heater 76 circulates hot fluid through the copper tubing 74 in order to heat the heating blanket 72 and thus the mould 20.

A hot-curing urethane resin can then be introduced into the mould funnels 70, and allowed to cure under heat provided by the heating blanket 72 in order to form the body 12.

Once the body 12 is cured, the tension on the hoses 14 can be released. The hoses 14 can then be decoupled from the threaded rods 44, and the completed hose loom arrangement 10 removed from the mould 20.

It will be appreciated that the saddles 60 remain embedded within the body 12.

The size, number and arrangement of hydraulic hoses 14 can be varied as required by use of appropriate outer plates 40. FIG. 8 shows other possible hose loom arrangements 10. It will be appreciated that other arrangements are also possible.

Modifications and variations as would be apparent to a skilled addressee are deemed to be within the scope of the present invention. For instance, although the invention has been described in relation to hydraulic hoses it will be appreciated that looms for other hoses can be formed in the same manner.

1. A hose loom arrangement comprising:
a plurality of hoses; and
a polymer body extending in a longitudinal direction, the polymer body encasing an axially extending portion of each of the hoses, wherein the polymer body includes a plurality of annular recesses longitudinally spaced along the polymer body.

2. A hose loom arrangement as claimed in claim 1, wherein each annular recess has an internal diameter which is greater than 80% of that of the polymer body.

3. A hose loom arrangement as claimed in claim 1, wherein each annular recess has an internal diameter which is less than 95% of that of the polymer body.

4. A hose loom arrangement as claimed in claim 1, wherein the hose loom arrangement includes at least one bracing member, the bracing member having a curved arm, the curved arm having a convex outer edge and a concave inner edge, the convex outer edge locating internally of an outer surface of the polymer body.

5. A hose loom arrangement as claimed in claim 4, wherein the convex outer edge of the curved arm has a radius of curvature less than that of the polymer body.

6. A hose loom arrangement as claimed in claim 4, wherein the bracing member includes at least two legs, the legs extending between the convex outer edge of the curved arm and the outer surface of the polymer body.

7. A hose loom arrangement as claimed in claim 1, wherein the polymer body is formed from a hot cure urethane.

8. A method for forming a hose loom arrangement, the method comprising the steps of:
providing a generally cylindrical mould;
locating a plurality of hoses such that an axially extending portion of each hose is within the generally cylindrical mould;
applying tension to each of the hoses such that the hoses extend through the mould in a generally linear fashion, the hoses being parallel to each other;
introducing a urethane resin into the mould; and
allowing the urethane to cure.

9. A method for forming a hose loom arrangement as claimed in claim 8, including the additional step of locating at least one bracing member between a base of the mould and the hoses before introducing the urethane resin.

10. A method for forming a hose loom arrangement as claimed in claim 9, wherein the bracing member has a curved arm, the curved arm having a convex outer edge and a concave inner edge, the convex outer edge of the curved arm having a radius of curvature less than that of the mould.

11. A method for forming a hose loom arrangement as claimed in claim 9, wherein the bracing member includes at least two legs, the legs extending between the convex outer edge of the curved arm and base of the mould.

12. A method for forming a hose loom arrangement as claimed in claim 8, wherein the mould is heated to between 20° C. and 100° C.

13. A method for forming a hose loom arrangement as claimed in claim 8, wherein the urethane resin introduced is a hot cure urethane.

14. A method for forming a hose loom arrangement as claimed in claim 8, wherein the mould includes a plurality of rings spaced axially along the mould, each ring having an outer diameter equal to that of the mould and an internal diameter greater than 80% of the outer diameter.

15. A method for forming a hose loom arrangement as claimed in claim 14, wherein each ring has an internal diameter less than 95% of the outer diameter.

16. A method for forming a hose loom arrangement as claimed in claim 8, wherein the mould is located within a tensioning unit, the tensioning unit having two complementary outer plates, each of the outer plates being provided with a plurality of apertures, such that each of the plurality of hoses corresponds with an aperture of a first outer plate and a corresponding aperture of the second outer plate, the outer plates being parallel to each other and spaced apart.

17. A method for forming a hose loom arrangement as claimed in claim 16, wherein each of the apertures is associated with an internally threaded member which is arranged to receive a threaded rod, the threaded rod has an outer end which is connected to an outer end of the respective hose, and the step of applying tension to the hoses is achieved by rotation of the threaded rods relative to the internally threaded members to effect axial movement of the threaded rod.

18. A method for forming a hose loom arrangement as claimed in claim 17, wherein the internally threaded members are integral to the apertures.

19. A method for forming a hose loom arrangement as claimed in claim 17, wherein internally threaded members are nuts located on an outer face of each outer plate.
